(19) United States
(12) Patent Application Publication
(10) Pub. No.: US 2018/0240100 A1
(43) Pub. Date: Aug. 23, 2018

(54) METHOD FOR SECURING A TRANSACTION FROM A NON-SECURE TERMINAL

(71) Applicant: SKEYECODE, Paris (FR)

(72) Inventor: Jean-Luc Leleu, Paris (FR)

(21) Appl. No.: 15/887,427

(22) Filed: Feb. 2, 2018

Related U.S. Application Data
(63) Continuation of application No. PCT/FR2016/052023, filed on Aug. 3, 2016.

(30) Foreign Application Priority Data
Aug. 4, 2015 (FR) 1557534

(51) Int. Cl. G06Q 20/32; G06Q 20/40; H04L 9/00; G09C 1/04; G09C 5/00

(52) U.S. Cl. CPC G06Q 20/3226; G06Q 20/4012; H04L 2209/16; G09C 1/04; G09C 5/00; H04L 9/002

(57) ABSTRACT

In a general aspect, a method can include: transmitting, to a terminal of the user via the server, an impenetrable program that can configure the terminal to display, on a display screen of the terminal, an image of a keypad having a randomly defined key distribution, the image including frames that are separately unintelligible for the user and are consecutively displayed at a rate suitable for using the persistence of the visual system of the user; executing the program via the terminal; gathering, via the terminal, positions of the display screen, designated by the user in relation to the displayed image of the keypad; transmitting, to the server via the terminal, the positions designated by the user, and verifying, via the server, the designated positions, the user being authenticated if the designated positions in the displayed image correspond to a secret authentication code of the user.

### CROSS REFERENCE TO RELATED APPLICATIONS

This application is a continuation of PCT Application PCT/FR2016/052023, filed Aug. 3, 2016, which claims priority to French Application No. 15 57534, filed Aug. 4, 2015, the disclosures of both of which are incorporated herein by reference in their entireties.

### TECHNICAL FIELD

The present disclosure relates to an authentication method between a terminal and a remote server.

### BACKGROUND

More and more services are available through a terminal connected to the Internet, including banking services. In particular, e-commerce has grown strongly. Terminals used in this context may be a personal computer, a digital tablet, a smartphone, etc. Generally, these terminals include a main processor, a graphics processing unit (GPU) connected or connectable to a display screen, circuitry for connecting to a data communications network such as the internet, and control means such as a keypad, mouse, or touch-sensitive surface associated with the display screen.

Access to so-called “online” services using such terminals raises security issues. Indeed, it is possible to install in the terminal, and to execute by the main processor of the terminal, a so-called “malicious” program having access to the entire memory available to the main processor, as well as to data displayed and entered using a keypad or at designated positions on an image displayed on the screen. Such a malicious program can be configured to snoop on possible transactions conducted from the terminal and to retrieve any secret data introduced or manipulated during these transactions for transmission over the network.

To ensure the security of such transactions, it has already been proposed to use as a security element and for cryptographic calculation a secure processor such as the processor of a SIM card (Subscriber Identification Module) provided in general with mobile phones. In order to run one or more payment applications, the secure processor must be able to store as many secret cryptographic keys as payment applications. However, loading an application into the memory of a secure processor is a complex operation that needs to be highly secured. For this purpose, it requires external interaction, such as with a Trusted Service Manager. As SIM cards are issued by a mobile operator, the mobile operator may refuse to install such applications in the card. In addition, in case of theft or during a maintenance operation of the phone, the processor of the SIM card may be subject to attacks by a fraudulent individual to discover the secret keys stored therein.

The access to secure functions installed in the processor of a SIM card generally requires the input of a secret code (PIN code) by means of the input device connected to the main processor of the terminal. As a result, a secret code entered by the user passes through the main processor. Malware executed by the main processor may therefore have access to this secret code.

For entering a secret code, it has also been proposed to display the image of a keypad whose keys are placed at random. This solution does not prevent a malicious program from obtaining the key combination introduced by the user by taking a screenshot of the keypad image and intercepting the position of each of the clicks made by the user using a mouse or a touch screen.

It has also been proposed to send the user a single-use code by another communication link (for example by SMS), which code is to be entered by the user to validate a current transaction. This solution involves additional manipulations by the user, and an additional cost for sending the single-use code. This solution is also not well suited for transactions conducted from a smartphone or a digital tablet.

In addition, use of the computing power of graphics processors installed in computers has already been proposed to perform cryptographic calculations. Indeed, such a processor has a parallel computing architecture that is well suited for performing certain cryptographic calculations such as symmetric or asymmetric encryption and decryption calculations. However, a graphics processor usually does not have nonvolatile memory. It is therefore not possible to store an application or a secret key, without them disappearing every time the computer turns off. This results in a problem of storing secret data used for conducting secure transactions.

In addition, the graphics processor cannot communicate directly with an external server. All the data of a transaction is therefore relayed by the main processor of the computer, managing the communication circuits of the computer. As a result, a malicious program installed in the computer can retrieve and store all the transaction data exchanged between the graphics processor and the server. Even if the transaction data is encrypted before transmission, the malicious program may reuse the encrypted transaction data to conduct a transaction identical to that corresponding to the stored data.

In current approaches, a transaction method can be implemented using a graphics processor for establishing a secure link with a remote server or a secure processor, where the graphics processor is configured to display an image of a keypad whose keys are at random positions. This image is broken down into unintelligible frames generated by a visual cryptographic process, which are displayed successively by the graphics processor. The frame display frequency is adjusted to exploit the user's retinal persistence so that the user can reconstruct the image from a plurality of successively displayed frames. Thus, a malicious program executed by the main processor of the terminal cannot recover the image reconstructed by retinal persistence, by taking a screenshot, since the frame display frequency is much higher than the rate at which the main processor can take screenshots.

However, this solution does not guarantee that an attacker cannot reconstruct the displayed image or a portion thereof presenting sensitive data, from successive partial screen shots.

It may therefore be desirable to protect secret data, and more generally, sensitive data such as transaction data, as they transit through a terminal having a graphics processor, or when transmitted between such a terminal and a server, or when they are entered by means of a keypad of the terminal.

### SUMMARY

In a general aspect, embodiments may relate to a method of authenticating a user by a secure processor, where the method can include: executing an impenetrable program configuring the terminal to display on a display screen of the terminal an image presenting selectable areas, each associated with a label or an icon and having a distribution in the image defined by first random data, the image comprising frames unintelligible individually for the user, displayed successively at a rate adapted to exploit the persistence of the vision system of the user so that the labels or icons appear on the screen display in an intelligible manner to the user, collecting by the terminal positions of the display screen designated by the user by means of an interface of the terminal, in relation to the displayed image, transmitting to a secure processor the positions designated by the user, the user being authenticated by the secure processor if the designated positions correspond to authentication data of the user, known to the secure processor.

According to an embodiment, the method can include transmitting at least part of the impenetrable program by the secure processor to the terminal.

According to an embodiment, the program can configure the terminal to display transaction data.

According to an embodiment, the program transmitted by the secure processor to the terminal can configure the terminal to display the labels or icons of the selectable areas in the image in positions in each area, and/or with a size, and/or with a font, specific to the program.

According to an embodiment, the display of the image by the terminal can include successively selecting a decomposition in complementary pixel patterns for each pixel or group of pixels of the image, representing the labels or icons of the selectable areas, and for each selected decomposition, generating complementary pixel patterns, so that the labels or icons of the selectable areas are visible on the display screen only if the complementary pixel patterns are displayed successively at a suitable rate to exploit the persistence of the vision system of the user.

According to an embodiment, the display of the image by the terminal can include successively displaying, by the terminal, the generated pixel patterns at randomly selected times, spaced apart by a variable duration, such that the human vision system can combine them although they are displayed successively, the display times of the pixel patterns forming a displayed image being distinct and independent of one another.

According to an embodiment, the impenetrable program transmitted by the secure processor to the terminal can configure the terminal to: generate the first random data from which the distribution of the labels or icons of the selectable areas in the image is defined, and transmit the first random data to the secure processor in encrypted form, the method can include: decrypting the first random data by the secure processor, determining by the secure processor the distribution of the labels or icons of the selectable areas in the image displayed by the terminal, and determining by the secure processor a secret code entered by the user from the positions designated by the user and the distribution of the labels or icons of the selectable areas.

According to an embodiment, the impenetrable program can include a random or pseudo-random number generation component for generating second random data used to select a complementary pixel pattern decomposition for each pixel or group of pixels in the image representing a label or an icon of a selectable area of the image.

According to an embodiment, the method can include establishing a link between the terminal and the secure processor, the link being secured by means of the first random data.

According to an embodiment, the impenetrable program transmitted by the secure processor to the terminal can configure the terminal to occupy at least 80% of the computing resources of the processor executing the program.

According to an embodiment, the impenetrable program transmitted by the secure processor and executed by the terminal can include a garbled circuit comprising logic gates distributed in several ordered levels, comprising a first level grouping logic gates exclusively receiving input values of the garbled circuit, the logic gates of a certain level receiving exclusively value from logic gates belonging to lower levels or input values of the garbled circuit, each logic gate being associated with garbled values representing each possible bit value of each input bit and each output bit of the logic gate, each logic gate being associated with a truth table including for each possible combination of the logic gate input binary values a value obtained by encryption of the garbled value representing the output value of the logic gate corresponding to the combination of the binary values input to the logic gate, the execution of the garbled circuit by a graphics processor can include: successively executing the levels of logic gates in the order of the levels, the execution of each of the levels of logic gates including executing all the logic gates of the level simultaneously, the execution of a logic gate can include selecting a row of the truth table associated with the logic gate, as a function of the garbled input values of the logic gate, and decrypting the selected row to obtain a garbled output value of the logic gate, and transferring the resulting garbled output values to apply them to a higher level logic gate input, from an output memory area to an input memory area so that they are taken into account when executing the next level of logic gates.

According to an embodiment, the execution of the garbled circuit can be performed by an interpreter itself realized at least partly in the form of a garbled circuit.

According to an embodiment, the first and/or second random data can be generated using a garbled circuit comprising a first level of logic gates associated with tables having identical rows but ordered differently, so as to provide different output data for the same input data, the output data of the first level of logic gates being provided to a next level of logic gates according to an order in which they are provided by the first level of logic gates.

According to an embodiment, the first and/or second random data can be generated by simultaneously causing the execution of several identical operations in parallel, the random data depending on the order in which the operations end.

According to an embodiment, the secure processor can be a server to which the terminal is connected.

According to an embodiment, the secure processor can be included in the terminal.

In another general aspect, embodiments may also relate to a terminal configured for: executing an impenetrable program configuring the terminal to display on a display screen of the terminal an image presenting selectable areas, each associated with a label or an icon and having a distribution in the image defined by random data, the image comprising frames unintelligible individually for the user, displayed successively at a rate adapted to exploit the persistence of the vision system of the user so that the labels or icons appear on the screen display in an intelligible manner to the user, collecting positions of the display screen designated by the user by means of an interface of the terminal, in relation to the displayed image, and transmitting to a secure processor the positions designated by the user, the user being authenticated by the secure processor if the designated positions correspond to authentication data of the user, known to the secure processor.

In another general aspect, embodiments may also relate to a terminal configured to implement one or the other of the previously defined methods.

In another general aspect, embodiments may also relate to a server configured for receiving from a terminal an authentication request from a user of the terminal, generating an impenetrable program executable by the terminal and configuring the terminal to display on a display screen of the terminal an image having selectable areas, each associated with a label or an icon and having a distribution in the image defined by first random data, the image including frames that are not individually intelligible to the user, displayed successively at a rate adapted to exploit the persistence of the user's vision system so that the labels or icons appear on the display screen in a manner that is intelligible to the user, transmitting to the terminal the generated impenetrable program, receiving from the terminal designated positions relative to the displayed image, and authenticating the user if the designated positions correspond to authentication data of the user, known to the server, the server being further configured to implement any of the methods defined previously.

In another general aspect, embodiments may also relate to a computer program which, when loaded and executed by a terminal, can configure the terminal to implement any of the previously defined methods.

In another general aspect, embodiments may also relate to a secret data sharing method, where the method can include: generating secret data in a graphics processor of a terminal, encrypting the secret data, and transmitting the encrypted secret data to a secure processor, the generating and encrypting the secret data being performed by a garbled circuit executed by the graphics processor and comprising logic gates distributed in several ordered levels, comprising a first level grouping logic gates exclusively receiving input values of the garbled circuit, the logic gates of a certain level receiving exclusively values coming from logic gates belonging to lower levels or input values of the garbled circuit, each logic gate being associated with garbled values representing each possible bit value of each input bit and each output bit of the logic gate, each logic gate being associated with a truth table including, for each possible combination of the logic gate input binary values, a value obtained by encryption of the garbled value representing the output value of the logic gate corresponding to the combination of the binary values input to the logic gate, the execution of the scrambled circuit by a graphics processor comprising: successively executing the levels of logic gates in the order of the levels, the execution of each of the levels of logic gates including executing all the logic gates of the level simultaneously, the execution of a logic gate comprising: selecting a row of the truth table associated with the logic gate, as a function of the garbled input values of the logic gate, and decrypting the selected row to obtain a garbled output value of the logic gate, and transferring the resulting output garbled values, which are applied to an input of a higher level logic gate, from an output memory of the graphics processor to an input memory of the graphics processor, so that they are taken into account when executing the next level.

According to an embodiment, the secret data can be generated randomly or pseudo-randomly, the scrambled circuit can include a random number generation or pseudo-random circuit.

According to an embodiment, the secret data can be generated randomly by simultaneously launching the execution of several identical operations running in parallel, the secret data can depend on the order in which the operations end.

According to an embodiment, the secret or random data can be generated using a garbled circuit comprising a first level of logic gates associated with tables having identical rows but ordered differently, so as to provide different output data for the same input data, the output data of the first level of logic gates can be provided to a next level of logic gates according to an order in which they are provided by the first level of logic gates.

According to an embodiment, the execution of the garbled circuit can be performed by an interpreter itself realized at least partly in the form of a garbled circuit.

According to an embodiment, the method can include establishing a link between the terminal and the secure processor, the link can be secured by means of the secret data shared only between the terminal and the secure processor.

In another general aspect, embodiments can also relate to a method of authenticating a user by a server, from a terminal connected to the server, the terminal comprising a main processor, a graphics processor controlling a display screen, and an interface, where the method can include: loading into the graphics processor a program configuring the graphics processor to execute the secret data sharing method as defined above, to generate secret data shared only between the graphics processor and the server, and to display on the display screen an image of a keypad having a defined and determinable key distribution using the shared secret data, executing the program by the graphics processor to generate the shared secret data and display the image of the keypad on the display screen, the image of the keyboard being displayed in the form of complementary frames which are not intelligible individually for a user, generated by a visual cryptographic algorithm and successively displayed at a rate adapted to exploit the persistence of the user's vision system so that an image combining the complementary frames appears in a manner intelligible to the user, collecting by the main processor positions of the display screen designated by the user by means of the interface, in relation to the displayed virtual keypad, transmitting by the main processor to the server the positions designated by the user, and checking a consistency between the designated positions, and a secret authentication code of the user, known to the server, the user being authenticated if the consistency is verified.

According to an embodiment, the shared secret data can define the distribution of the keys of the keypad image.

According to an embodiment, the display of the keypad image can include: successively selecting a decomposition in complementary pixel patterns for each pixel or group of pixels of the keypad image, representing key labels of the keypad, successively generating complementary pixel patterns for each selected decomposition, so that the key labels are only visible on the display screen if the complementary pixel patterns are superimposed, and successively displaying pixel patterns generated at randomly selected times spaced by a variable duration such that the human vision system can combine them although they are displayed successively, the times of display of the pixel patterns forming a displayed image of the keypad being distinct and independent of each other.

According to an embodiment, the display of the keypad image can be performed by a garbled circuit executed by the graphics processor.

In another general aspect, embodiments can also relate to a terminal configured to implement one or the other of the previously defined methods.

In another general aspect, embodiments can also relate to a computer program which, when loaded and executed by a terminal including a main processor and a graphics processor, configures the terminal to implement one or the other of the previously defined methods.

### BRIEF DESCRIPTION OF DRAWINGS

FIG. 1 schematically represents a conventional terminal in communication with a transaction server,

FIG. 2 schematically represents a conventional graphic processor,

FIG. 3 diagrammatically represents a functional architecture of a program loaded in the graphics processor, according to an embodiment,

FIG. 4 schematically represents a component of the program loaded in the graphics processor, according to an embodiment,

FIG. 5 diagrammatically represents a cryptographic display component of the program loaded in the graphics processor, according to an embodiment,

FIG. 6A represents an exemplary image produced by the cryptographic display component, such as it can be viewed by a user,

FIG. 6B represents an exemplary image produced and displayed by the cryptographic display component, at a specific time,

FIG. 7 schematically represents image pixel patterns displayed successively on a display screen by the cryptographic display component, according to an embodiment,

FIG. 8 schematically represents on a time scale display and refresh times of pixel patterns generated by the cryptographic display component,

FIG. 9 schematically represents an encryption component of the program loaded into the graphics processor, according to an embodiment,

FIG. 10 shows steps performed by the terminal and the transaction server, according to an embodiment.

### DETAILED DESCRIPTION

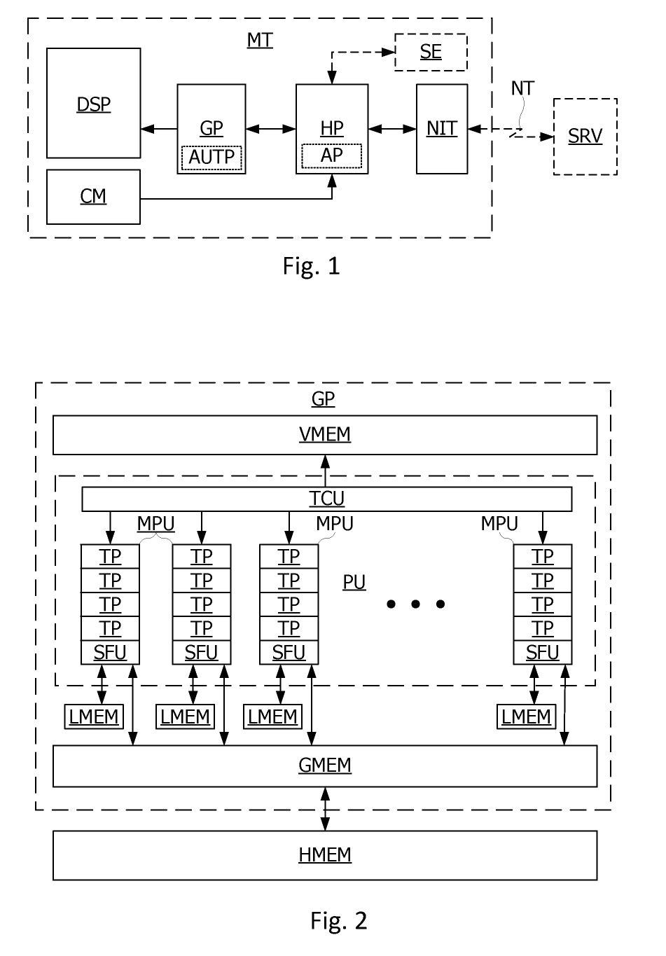

FIG. 1 represents a conventional terminal MT capable of communicating with a server SRV via a data transmission network such as the Internet. The server SRV may be configured to conduct transactions with terminals to which it may be connected.

The terminal MT is equipped with circuitry for connecting to a network such as the Internet. The terminal MT is for example a mobile phone, in particular a smartphone, or a PDA (personal assistant) or any other type of device, such as a personal computer equipped with circuitry for connecting to a network such as the Internet. The terminal MT also comprises a main processor HP, circuitry NIT for connecting to a network NT, connected to the processor HP, a display screen DSP, a graphics processor GP for controlling the screen DSP, connected to the processor HP, and a control device CM connected to the processor HP. The control device may comprise a keypad or a touch-sensitive surface, for example a transparent touch surface placed over the screen DSP, and optionally a pointing device such as a mouse. The processor HP can be the main processor of the terminal (“Baseband processor”).

The terminal may also include a secure processor SE, which can be implemented in a UICC (“Universal Integrated Circuit Card”). The processor SE may for example be that of a SIM card (“Subscriber Identity Module”), or mini-SIM or micro-SIM, providing access to a mobile phone network. The secure processor may include an NFC (Near Field Communication) circuit to communicate with a contactless terminal. The NFC circuit can be embedded in a SIM card (SIM-NFC) or UICC, or in a SoC (“System on Chip”) or in an external memory card, for example an SD card. The NIT circuits may include radio-telephone circuits providing access to a mobile telephone network, and to the Internet via the mobile telephone network, and/or a wireless network interface (WiFi, Bluetooth), and/or any other wired or wireless connection means to a data transmission network such as the Internet.

The server SRV is configured to provide transaction services to users. It may include a security device, a transaction service management program, and a memory area dedicated to program storage and transaction data. The security device protects the server and in particular the access to the memory area dedicated to the transaction data and the transaction service management program.

Hereinafter, the term “transaction” generally refers to an access by a user to a service or data, through a link, which access requires authentication of the user.

FIG. 2 shows an example of graphics processor GP. In FIG. 2, the processor GP has a parallel architecture comprising several multiple processing units MPU. Each MPU comprises several thread processors TP and a special function unit SFU. The SFUs are configured to perform infrequent operations that are expensive in computing resources, such as division, square root, etc. The processors TP of a same MPU can communicate with each other via a local memory LMEM specific to the MPU. On the other hand, TP processors belonging to different MPUs cannot communicate with each other nor synchronize. The TP processors of an MPU therefore do not have access to the local memories LMEM of the other MPUs of the GP processor.

The MPUs are managed by a Thread Execution Control Unit (TPU). The GP processor also includes a video memory VMEM and a main memory GMEM that is not accessible directly from outside the GP processor. Conversely, the memory HMEM of the HP processor is not directly accessible by the GP processor. However, data transfers between the GMEM and HMEM memories are possible via an input/output port of the GP processor and a DMA (Direct Memory Access) operation.

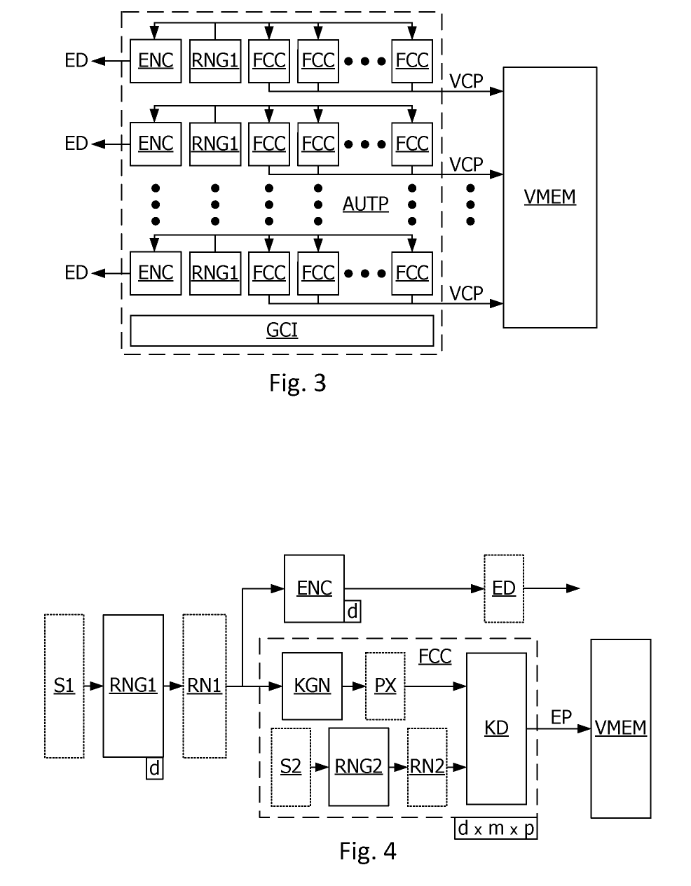

FIG. 3 shows a functional architecture of a program AUTP loaded into, and executed by the processing unit PU of the graphics processor GP, when executing a transaction application AP (FIG. 1) by the main processor HP of the terminal MT. According to an embodiment, this program includes multiple display components FCC executed in parallel, each display component FCC being in charge of writing and refreshing in the video memory a pixel pattern VCP to be displayed on the display screen DSP. The program loaded in the graphics processor GP also includes encryption components ENC, and random number generation components RNG1 providing random numbers to the display components FCC and encryption components ENC. The encryption components ENC provide encrypted numbers outside the processor GP corresponding to the random numbers provided by the components RNG1.

FIG. 4 depicts one of the display components FCC of the program AUTP loaded in the graphics processor GP, according to an embodiment. The component FCC includes a component for generating pixels of a keypad image KGN, and a visual cryptography component KD. One of the random number generation components RNG1 receives as input a number D1 used as a seed. The component RNG1 provides a random or pseudo-random number RN1 to m x p components FCC. The random number RN1 provided at the input of the component KGN designates a character, such as a numeric or alphanumeric character, or an icon of a keypad image to be displayed. The component KGN provides the value of a pixel PX, black or white, of a picture forming the character corresponding to the number RN1. The random number RN2 is provided at the input of the component KD. The component KD successively provides pixel patterns PT to be displayed as a function of the pixel PX supplied by the component KGN.

All the components KGN loaded in the processor GP thus generate together in the video memory VMEM a complete image of a keypad composed of d juxtaposed key images, each key image including the picture of a different character assigned to the key. Thus, the ensemble of components KGN loaded in the processor GP includes a group of m×p components KGN per key of the keypad to be displayed, each of these groups of components KGN producing an image of m×p pixels representing a key with the character assigned to the key. Each of these groups of m×p components KGN receives from the component RNG1 a distinct number corresponding to the picture of the character to be displayed on the key.

According to an embodiment, a first of the d groups of components KGN in charge of displaying the image of a key receives, from the corresponding component RNG1, a random number RN11 chosen between 1 and the number of keys of the keypad to be displayed. A second of the groups in charge of displaying the image of a key receives as input a number RN12 randomly selected between 1 and the number of keys of the keypad to be displayed, decreased by 1, d−1, the number RN12 then corresponding to a character rank among the remaining characters to be assigned to the remaining keys. The numbers RN1i are thus randomly chosen according to the number of characters remaining to be assigned to a key, until the penultimate character to be assigned to a key on the keypad. The last character is assigned to the remaining key.

The component KGN may also receive the position of the pixel generated by the component KGN in the image displayed by the screen DSP. However, the position PXPi may not be used, because the position of the component FCCi in the processing unit PU is usable to define this position.

The component KD applies a visual cryptography transformation to the pixel PXi, as a function of a random or pseudo-random number RN2. This transformation can include decomposing an original image, for example human intelligible, into a set of several complementary frames, so that the original image is restored only by superimposing all the frames of the set of complementary frames, and such that it is very difficult to reconstruct the original image in the absence of any one of the complementary frames. Thus, the component KD generates for each frame to be displayed on the screen DSP a pattern of one or more pixels EPi corresponding to an encrypted form of the pixel PXi. Thus, the value of the pixel PXi may appear on the display DSP by successively displaying the complementary patterns EPi of the pixel PXi, with a frame display rate suitable for exploiting the retinal persistence of the user's vision system.

According to an embodiment, the complementary pixel patterns EPi are displayed separately at randomly defined times within a limit compatible with the human vision system. FIG. 5 depicts a component KD according to an embodiment. The component KD includes a component PSL for generating pixel patterns, and a counter circuit comprising a register RG, a modulus computing component MOD, a comparator CMP and an incrementing component INC. The register RG receives a part RN21 of the random number RN2, which defines an initial value of the counter circuit. The MOD component calculates the modulus of the number in the register RG. The INC component increments the output value of the MOD component by one and feeds the incremented value into the register RG. The output value of the MOD component is also provided as an output of the component KD and to an input of the comparator CMP. The comparator CMP compares the output value of the component MOD with a part RN22 of the random number RN2. The comparator CMP provides the component PSL with a display enable signal DS that is active when the two input values of the comparator CMP are equal. The component PSL selects a pixel pattern from among a plurality of pixel patterns based on a part RN23 of the random number RN2. Upon a first activation of the DS signal, the PSL component outputs the selected pixel pattern from the KD component as the first pixel EP1 of a set of complementary pixels. At a second activation of the DS signal, the PSL component outputs either the selected pixel pattern or the complementary pixel pattern thereof from the KD component as the second pixel EP2 of the set of complementary pixels, depending on the value of the pixel PX provided at the input of the component KD. For example, the second pixel pattern EP2 is the selected pixel pattern if the value of the pixel PX supplied at the input of the component KD is zero, or the complementary pixel pattern if the value of the pixel PX is one. Of course, an inverse choice may be made as a function of the value of the pixel PX. Thus, thanks to the counter circuit, the time at which the KD component outputs a first pixel pattern is chosen randomly by the random number RN21. The output times of the next pixel patterns are also randomly chosen according to the random number RN22, which may change each time a pixel pattern EP1, EP2 is output from the component KD. The value of the modulo used by the component MOD is chosen so that the display times of the pixel patterns EP1, EP2 are spaced by a duration compatible with the human vision system, that is to say a duration such that the human vision system can combine the complementary pixel patterns. For this purpose, the duration may vary between 50 and 80 ms. The first pixel pattern EP1 is also randomly selected each time two pixel patterns have been output from the KD component.

In the example of FIG. 5, the pixel patterns have four pixels including two black pixels and two white pixels. The selection of the first pixel pattern EP1 is carried out among six patterns, namely two horizontal patterns, two vertical patterns and two diagonal patterns. Of course, other patterns and other combinations of complementary patterns may be envisioned to form a black or white (gray) pixel in the user's vision system.

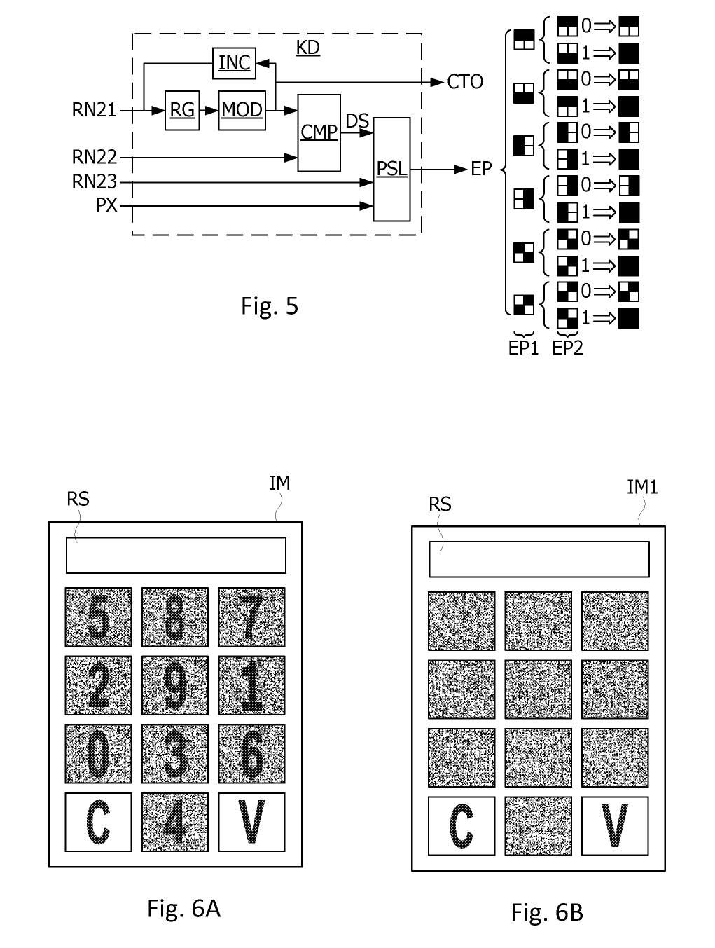

The set of FCC components makes it possible to generate and display an image such as that presented in FIG. 6A, comprising visual cryptography displayed zones and zones displayed in clear. Thus, in the example of FIG. 6A, the image IM perceptible by a user is that of a keypad having twelve keys, including keys bearing a number from “0” to “9”, a cancel key “C” and a validation key “V”. Thus, in the exemplary image of FIG. 6A, the program AUTP includes ten RNG1 components and 10×m×p FCC components (d=10). The displayed image also includes a display area RS for transaction data and/or a generic character such as “*” for each key operated by the user. The keys bearing a number from “0” to “9” are presented in any order and are displayed using visual cryptography, by successively displaying pixel patterns EP1, EP2 at random selected times. FIG. 6B shows an image IM1 actually produced and displayed by the PSL component. The image IM1 includes only one of the two pixel patterns EP1, EP2 of one of the sets of complementary pixel patterns generated for each pixel PX of the areas displayed in visual cryptography of the image produced by the component KGN. The labels of the keys bearing a number from “0” to “9” are therefore not visible in the image IM1. Note that the validation and cancellation keys may also have a position defined at random in the image.

According to an embodiment, the KGN components are executed once to generate the image of a keypad with a defined key distribution, and the RNG2 and KD components are executed several times, at a rate of the order of once every period T, T being of the order of two to ten milliseconds, to provide a pixel pattern VCP in the memory VMEM every 50 to 80 ms, for example, until the user activates the cancel key “C” or validation key “V”. The modulo value applied by the MOD component depends on the value of the period T and the maximum duration between the successive display times of a pixel pattern. According to an embodiment, the content of the memory VMEM is displayed at each of the periods T.

According to an embodiment, the KGN components are executed at a certain rate, to generate different images, but without changing the distribution of the keys from 0 to 9 in the keypad image, so as to render even more difficult the determination by an attacker of the distribution of the keys from 0 to 9. The different images thus generated may for example change the position of the label (from “0” to “9”) of each key within the corresponding surface area of the key, and/or change the size of the label, and/or change the font used for the label.

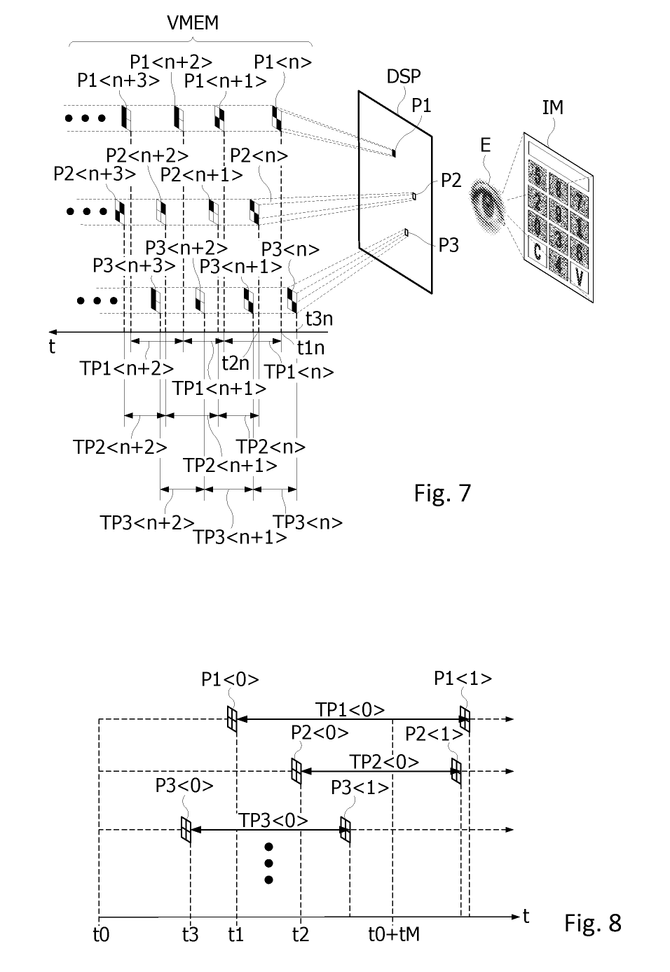

FIG. 7 shows the image IM seen by the user on the screen DSP of the terminal. According to an embodiment, at least a portion of the image IM results from refreshing pixel patterns at different rates, the pixel patterns of a first image being displayed at different times. FIG. 7 depicts pixel patterns P1<n>, P1<n+1>, P1<n+2>, P1<n+3>displayed successively at a position P1 of the display screen DSP, pixel patterns P2<n>, P2<n+1>, P2<n+2>, P2<n+3>successively displayed at a position P2 of the display screen, and pixel patterns P3<n>, P3<n+1>, P3<n+2>, P3<n+3>successively displayed at a position P3 of the display screen. The pixel patterns Pi<j>(j=n, n+1, n+2, n+3, . . . ) result from different successive decompositions, through visual cryptography, of a pixel or group of pixels at a position Pi of an original image, in sets of complementary pixel patterns. This decomposition is performed by the KD components of the FCC components, so that the original image can be restored only by superimposing all the pixel patterns of a set of complementary pixel patterns, and that it is very difficult to determine the value of a pixel in the original image in the absence of any one of the pixel patterns of the set of complementary pixel patterns or in the presence of a pixel pattern belonging to another set of complementary pixel patterns.

According to an embodiment, each pixel pattern Pi<j>is displayed for a distinct respective duration TPi<j>(i=1, 2, 3, . . . and j=n, n+1, n+2, n+3, . . . ) determined so that the retinal or visual persistence of the user recombines the pixel patterns of each set of complementary pixel patterns, and thus so that the user perceives the original image IM formed of the superimposition of all the complementary pixel patterns assigned to this image.

For example, the pixel patterns Pi<n>and Pi<n+1>(i=1, 2, 3, . . . ) form a first set of complementary pixel patterns, resulting from a first decomposition by visual cryptography, and Pi<n+2>and Pi<n+3>(i=1, 2, 3, . . . ) form a second set of complementary pixel patterns, resulting from a second decomposition by visual cryptography, distinct from the first decomposition. Of course, a pixel or group of pixels of an original image may be decomposed by visual cryptography in addition to two complementary pixel patterns.

Pixels or groups of pixels of the original image displayed in the form of complementary pixel patterns are distributed in the image so as to make all or part of the image unintelligible if complementary pixel patterns are not superimposed. Thus, the image IM of FIG. 6 (as it appears to the user) has a keypad whose keys are arranged in an arbitrary order, for example determined randomly. According to an embodiment, the pixels delimited by the shape of the keys and representing the labels of the keys are broken down into complementary pixel patterns through visual cryptography. Of course, it may be envisioned to decompose by visual cryptography all the pixels of the image IM.

According to an embodiment, the display duration TPi<j>(i=1, 2, 3, . . . and j=n, n+1, n+2, n+3, . . . ) of each pixel pattern is set to a value that varies in time and from one pixel pattern to another, between 50 and 80 ms. According to an embodiment, first pixel patterns displayed at the beginning of the presentation of an image on the display screen DSP are displayed at distinct times. Thus, FIG. 8 represents, along a time axis, display times t1, t2, t3 of first pixel patterns P1<0>, P2<0>, P3<0>displayed at positions P1, P2, P3 of the original image IM. The times t1, t2, t3 are separated from a start time t0 of the beginning of the display of the image by less than a duration tM, which may be chosen less than or equal to 50 ms, considering that certain pixel patterns of the image may be displayed as soon as time t0. Second pixel patterns P1<1>, P2<1>, P3<1>are displayed after the first pixel patterns P1<0>, P2<0>, P3<0>at times that vary from one pixel pattern to the other, separated from the display times of the first pixel patterns by respective durations TP1<0>, TP2<0>, TP3<0>between 50 and 80 ms.

Thus, if each pixel or group of pixels of the original image is decomposed into two successive complementary pixel patterns, and assuming that two successive screen copies can be made and stored by the processor HP in 50 ms or less, the second screenshot cannot contain all the pixel patterns complementary to the pixel patterns in the first screenshot. Indeed, since the pixel patterns are displayed from distinct times and are refreshed at different variable refresh periods, the first screenshot contains pixel patterns complementary to previously displayed pixel patterns, and therefore the second screenshot contains pixel patterns complementary to pixel patterns that will be displayed after the second screenshot. A third screenshot can be made to obtain these complementary pixel patterns. However, it is not possible to determine whether a pixel of the original image, for example P1, is reconstructed from the corresponding pixel pattern of the first and second screen shots (P1<n>, P1<n+1>) or that of the second and third screenshots (P1<n+1>, P1<n+2>). If all the pixels of the original image are thus decomposed into two complementary pixel patterns, the reconstruction of the original image requires the selection, for each pixel pattern of the image transformed by visual cryptography, of the correct pair of complementary pixel patterns in the pair including the corresponding pixel patterns in the first and second screen shots and the pair including the corresponding pixel patterns in the second and third screen shots. In this case, the processor HP should be capable of performing and storing at least three successive screen copies within 50 ms, each screen copy requiring the video memory VMEM to be read, and the read data to be written into a memory HMEM accessible to the processor HP.

If each pixel of the original image is transformed by visual cryptography into a set of three or more complementary pixel patterns, the problem of reconstructing the original image from successive screen copies is even more complex.

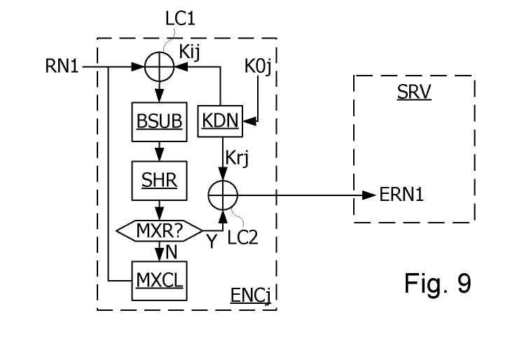

FIG. 9 represents one of the encryption components ENCj installed in the processor GP, according to an embodiment. The component ENCj receives a random number RN1 transmitted by one of the RNG1 modules and encrypts it by applying an encryption algorithm to calculate an signature ERN1. All signatures ERN1 thus calculated by the ENCj components are transmitted outside the processor GP, for example to the server SRV.

In the example of FIG. 9, the component ENCj implements the AES algorithm (Advanced Encryption Standard). Thus, the ENC component executes several (r+1) rounds of encryption. In the first round, the component ENCj combines by a function LC1, a bitwise Exclusive OR (XOR) operation, an initial key portion K0j with the random number RN1 received from the component RNG1. The result of this combination is transmitted to a non-linear substitution function BSUB replacing each byte of the combination with another according to a correspondence table. The result of the substitution is transmitted to a transposition function SHR that cyclically shifts a number of times the last three rows of the substitution result formatted in a block of several rows and columns. The result of the transposition is transmitted to a mixing function MXCL. The function MXCL is applied per column to the block resulting from the transposition and combines the last four bytes of each column of the block. The result of the mixing is combined with a new key K1j derived from the initial key by a function LC2, also a bitwise Exclusive OR (XOR) function. These functions BSUB, SHR, MXCL are executed at each round i with a new key Kij derived from the key used in the previous round by a key derivation function KDN. In the last round r, when a maximum number of rounds MXR is reached, the function MXCL is not executed, the result of the transposition function SHR being combined with a last key Krj derived from the key used in the previous round.

It may be observed that if the encryption function implemented by each component ENCj is reversible, as is the case of the AES algorithm, the ENCj components can be used to establish a transmission channel between the server SRV and the processor GP, which is secured by symmetric encryption using a secret key known only to the server SRV. Here and in the following, the term “secure” means protected against fraudulent access by hardware and/or software elements.

According to an embodiment, the RNG1, ENC and FCC components are implemented in the form of circuits or impenetrable (“obfuscated”) executable code, so that their operation is completely hidden and cannot be modified. The RNG1, ENC and FCC components may be generated by the server SRV such that they embed in their internal structure a respective secret key specific to an identifier of the user.

According to an embodiment, the RNG1, ENC and FCC components are implemented in the form of logic circuits including logic gates such as AND, NAND, OR, NOR, XOR, then transformed by the “garbled circuits” technique. The transformation of the RNG1 and FCC components into logic circuits may be carried out using conversion tools of programs written, for example, in C or C++ language, into languages such as VHDL or Verilog. This garbled circuit transformation technique randomly generates garbled values representing each binary value 0 and 1 of each input bit of the circuit and each logic gate output bit of the circuit, some logic gate outputs corresponding to outputs of the circuit, to represent each gate by its truth table, and to encrypt each truth table, by encrypting the garbled value representing the output binary value of each row of the truth table, using as keys, the garbled values of the logic gate input corresponding to the row of the truth table. A bit of determined rank of each garbled value, for example the least significant bit (LSB), may be used to determine the correspondence between a garbled value and its corresponding binary value 0 or 1. The so determined bit may be used to select in the truth table of a logic gate the garbled output value corresponding to the input garbled values of the logic gate. The garbled output value of each gate can therefore be obtained by applying a decryption algorithm corresponding to the used encryption algorithm, to the garbled output value thus selected, using as keys the garbled values applied at the input of the logic gate. The circuit topology (connections between circuit inputs, logic gate outputs, and logic gate inputs) may be defined in a table.

In this manner, it is not possible to determine the operation of the RNG1, ENC and FCC components when transformed into garbled circuits, and the circuits only operate with some input values among a large number of possible values. More details on garbled circuit techniques may be found, for example, in the document “Foundations of Garbled Circuits”, Mihir Bellare, Viet Tung Hoang, Phillip Rogaway.

These techniques for generating and executing garbled circuits can be easily adapted to an implementation by a processor having a SIMD (Simple Instruction Multiple Data) architecture, such as graphics processors. For this purpose, the logic gates of the garbled circuit are divided into rows, the logic gates of first rank being those receiving exclusively input values of the garbled circuit, and the logic gates of a given rank n, receiving exclusively values from lower rank logic gates or input values of the garbled circuit.

According to an embodiment, the garbled values are defined over 4 pixels of 4 bytes, i.e. 16 bytes. The truth tables of the logic gates are thus defined by four garbled values, i.e. 64 bytes corresponding to each combination (0, 0), (0, 1), (1, 0), (1, 1) of the input binary values. The topology of the garbled circuit can be defined from a numbering of each circuit connection, including the inputs of the circuit, from 1 to n, then each output of a logic gate of the circuit, from n+1 to n+q, the outputs of the circuit being assigned the highest numbers, from n+qm+1 to n+q, and the logic gates being referenced by the number of their output connection, from n+1 to n+q. The topology of the garbled circuit can thus be stored in the form of a table gathering for each logic gate of the circuit the numbers of the input connections of the logic gate.

The execution of the garbled circuit by the processor GP may be performed by a garbled circuit interpreter component GCI configured to operate in iterations, by executing at each iteration the logic gates of a row, starting with the logic gates of first rank. Prior to the execution of the first rank logic gates, the topology tables, the logic gate truth tables and the input garbled values are loaded into the GP processor's input memory, i.e. the memory GMEM. At each execution of the logic gates belonging to a rank, the component GCI is configured to transfer the garbled values obtained as a result of the execution of the logic gates of the rank of an output memory of the processor GP, that is to say say the memory VMEM, in the input memory GMEM, to provide them to the inputs of the logic gates of the next rank to be executed. In this transfer, only the garbled output values used as input values of the logic gates of the next rank are transferred. At the end of the garbled circuit execution, the garbled output values are in the memory VMEM, and can be transferred to the processor HP.

In this manner, the encryption circuit ENC, which contains the encryption key, remains known only to the entity that generated it, in this case the server SRV. It should be noted that the processor HP can access the contents of the memories VMEM and GMEM through read commands transmitted to the processor GP.

The component RNG1 may be realized as a garbled circuit, for example, by a circuit including a first level of logic gates obtained by duplicating a garbled logic gate a large number of times and by exchanging in each truth table of the logic gates of the first level, the rows of the truth table, containing the garbled values of the corresponding gate. The component RNG1 may include a second level or more of logic gates, each including logic gates also obtained by duplicating another garbled logic gate or the garbled logic gate used to generate the logic gates of the preceding level, and by exchanging in each truth table of the first rank logic gates, the rows of the truth table. Each logic gate of the second level and any higher levels combines logic gate outputs of the lower level. According to an embodiment, the entropy source of the component RNG1 is obtained by exploiting the parallel architecture of the processor GP, which executes the garbled logic gates of same rank in parallel. In such an architecture, it is not possible to determine in advance in which order the garbled output values of the garbled logic gates of the currently executed rank will be supplied. The garbled output values of the logic gates being executed are injected as inputs to the garbled logic gates of the next rank, in the order in which they are obtained. Thus, the garbled values obtained at the output of the last rank of logic gates have a certain random character.

It is also possible to achieve the component RNG1 such that it includes several levels formed from a same duplicated logic gate, each duplicated logic gate having a truth table whose rows may be ordered differently relative to the table of another logic gate. Thus, the inputs of the component RNG1 may be used at the input of several of the levels of logic gates of the component RNG1.

The component RNG1 may also be realized in the form of a garbled circuit implementing counters, some counters controlling the stopping of other counters. The values of the counters thus stopped form a basis for defining a random value.

The component RNG1 may also include logic gate levels implementing an encryption algorithm such as AES applied to the output values of logic gates of lower levels.

The component RNG2 can be realized in a form similar to that of the component RNG1, by duplicating a logic gate and reordering the rows of the truth tables of the duplicated logic gates. The component RNG2 can also be embodied as a garbled circuit configured to derive garbled values from the garbled values RN1. In this case, the values RN1 are also applied at the input of the component RNG2 instead of the values S2, in FIG. 4.

All or part of the component GCI may also be realized in the form of a garbled circuit. For example, the function of the component GCI responsible for decrypting a row of the truth table of each logic gate of the row being executed to obtain the garbled output value of the logic gate, may be realized in the form of a garbled circuit as previously described.

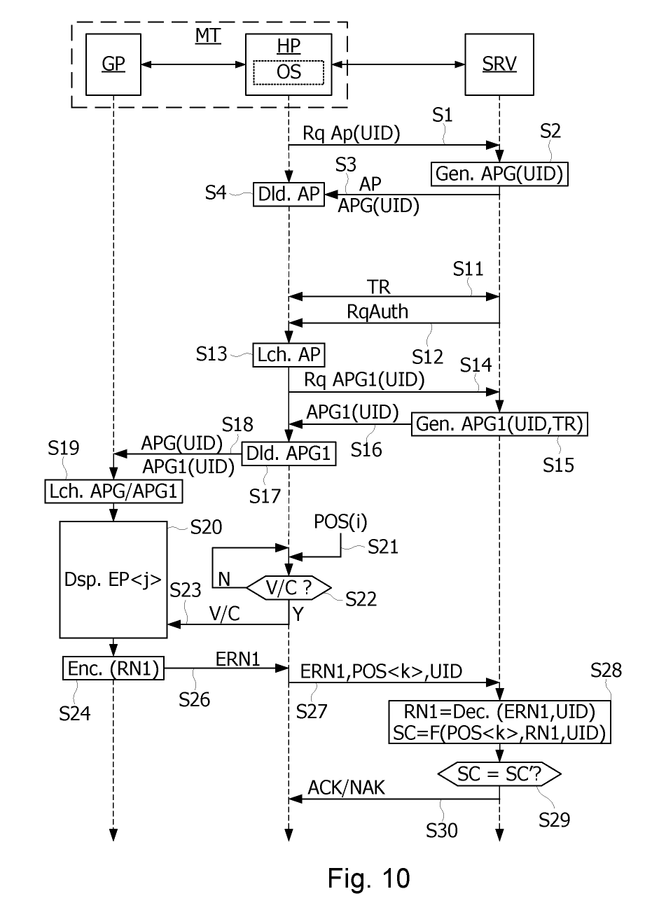

FIG. 10 shows steps (which can also be referred to as operations, processes, etc.) performed to authenticate the user of the terminal, according to an embodiment. Steps S1 to S4 are provided for installing an application AP with a user authentication function. In step S1, the processor HP of the terminal MT transmits a request Rq for downloading the application AP associated with a user identifier UID. In step S2, the server SRV receives this request Rq and generates an program APG to be loaded in the graphics processor GP of the terminal MT. The APG program is generated at least partly in the form of impenetrable code from secret data generated specifically for the UID of the user. In step S3, the server SRV transmits to the terminal MT, in response to the request Rq, the application AP and the program APG to be installed in the processor HP and in the processor GP. In step S4, the processor HP receives the application AP and the program APG and stores them in nonvolatile memory, and then installs the application AP.

Steps S11 to S29 are executed during a transaction or an access to a service requiring authentication of the user. In step S11, a preliminary processing at the conclusion of a transaction is performed by the processor HP and the server SRV or another server. In step S12, the terminal MT receives an authentication request from the user Rqauth. In step S13, the processor HP of the terminal MT initiates the execution of the application AP in response to the receipt of the request RqAuth. Note that the conduct of the transaction or of the access to a service can be performed by the application AP. In this case, the application AP was started before step S11. In step S14, the application AP executed by the processor HP transmits to the server a request for a graphics processor program APG1, this request containing the identifier UID of the user, and possibly information relating to the transaction, to be presented to the user on the screen DSP of the terminal MT. In step S15, the server SRV receives this request and generates a program APG1 to be loaded into the graphics processor GP of the terminal MT, in addition to or in replacement of all or part of the program APG. Here again, the program APG1 is generated at least partly in the form of impenetrable code or garbled circuits from secret data generated specifically for the UID of the user. The program APG1 includes programs forming components FCC that can be designed to display transaction data such as a price to pay and the recipient of the payment. Some FCC components in the program APG1 may also replace keypad display components in the program APG, such as to display key labels differently (positions, sizes, and font of the labels).

In step S16, the server SRV transmits the program APG1 it generated for the user identifier UID. In step S17, the terminal MT receives the program APG1 and loads it into the volatile memory of the terminal MT in addition to or replacing all or part of the program APG already stored in this non-volatile memory to form a program APG-APG1. In step S18, the processor HP transmits the program APG-APG1 from the non-volatile memory to the memory GMEM of the processor GP. In step S19, the processor GP loads and starts the program APG-APG1. During steps S20 and S24, the processor GP is controlled by the program APG-APG1. In step S20, the processor GP triggers the display on the screen DSP of a keypad whose keys are located at randomly chosen positions, by executing the previously described components RNG1 and FCC. Thus, the display of the keypad by the processor GP is achieved by applying a visual cryptography algorithm so that a screen copy does not provide the configuration of the keys of the keypad, as explained above.

During the execution of step S20 by the processor GP, the HP processor executes steps S21 and S22. In step S21, the processor HP acquires positions POS(i) on the screen DSP, as activated by the user by means of a mouse or the touch surface CM. In step S22, if one of the activated positions corresponds to the position of the validation key “V” or cancellation key “C”, the processor HP sends in step S23 to the processor GP a validation or canceling message, indicating to the processor GP that it can remove the keypad image from the image displayed on the screen DSP. The reception of this message by the processor GP terminates the keypad display step S20, and if the received message is a validation message, the processor GP executes the step S24 where the components ENC of the program APG-APG1 encrypt the garbled random values RN1 generated by the components RNG1, to generate the image of the keypad to be displayed. In step S26, the processor GP supplies the encrypted values ERN1 that it calculated in step S24 to the processor HP. In step S27, the processor HP transmits to the server SRV the garbled values ERN1, the positions POS(i) introduced by the user, as well as the UID of the user. In step S28, the server SRV receives and checks this information, then processes it to verify it by decrypting the encrypted values ERN1. The decryption of the encrypted values ERN1 is performed by the server SRV by executing a garbled circuit corresponding to the component ENC, and by using keys Krj stored in association with the UID of the user. This decryption operation produces the garbled random values RN1. The decoding of the garbled values RN1 to determine the original binary values of these values determines the order of the keys of the displayed keypad. The secret code SC entered by the user is determined from the entered positions POS(i) and the order of the keys of the displayed keypad. In step S29, the server SRV verifies that the secret code SC thus introduced by the user and obtained corresponds to a secret code SC′ stored in association with the UID of the user. If this is the case, the server SRV considers that the user has been authenticated. The server SRV can then validate a transaction or inform a possible server party to the transaction. In step S30, the server SRV informs the terminal MT of the success or failure of the authentication of the user. The processor HP can then display a notification informing the user of the success or failure of the transaction.

According to an embodiment, the program APG-APG1 is configured to occupy at least 80% of the computing resources of the processor GP. In this manner, the operation of the processor GP will be disturbed if another program is loaded for execution by one or more units TP or SFU of the processor GP. Thus, it is ensured that the image displayed on the screen DSP is not displayed by another program executed by the processor GP.

According to an embodiment, the character of each key can be displayed in the image of the key at a variable position, size and font defined in the program APG1 downloaded with each transaction. Thus, the program APG1 may contain the definition of one or more of the keys of the keypad to be displayed.

Steps S11 to S30 can be implemented for various applications, such as access to a service, validation of an online payment transaction, or an electronic voting service. In the case of an electronic voting service, the program APG1 provided by the server SRV during the execution of the application AP may include FCC components for displaying the names of the candidates to vote for, each associated with a key of a keypad whose keys are distributed randomly in the image displayed by the terminal MT. The user for example selects a candidate by activating a key of the keypad corresponding to the candidate for which he wishes to vote and enters a secret code by activating a set of keys, allowing the server SRV to authenticate the user.

Furthermore, the component RNG1 coupled to the encryption component ENC, implemented in the form of an impenetrable program such as a garbled circuit, can also be implemented in an application for establishing a secure communication channel between the processor GP and a secure processor or the server SRV, on the basis of secret data (garbled random values RN1) shared only by the processor GP and the server, and which are not accessible outside the processor GP and the server. The secure communication channel may be achieved using an encryption algorithm implemented by the processor GP and the server SRV, by using the secret data as an encryption key or by deriving a same encryption key by the processor GP and the server SRV. The program APG, APG1 then includes a decryption component for decrypting data transmitted and encrypted by the server SRV, using the secret data. A procedure analogous to that of FIG. 10 may be implemented, the procedure comprising steps S11 to S28, but having no step S20 for displaying an image, nor steps for determining the secret code SC (S28) and comparing this secret code with an expected value (S29).

The components RNG1, ENC and FCC may also be implemented to generate and display a single-use code on the screen DSP of the terminal.

It should be noted that the random numbers at the input of the component KGN for generating the image of the keypad to be displayed or for generating a single-use code to be displayed can be transmitted by the server SRV to the processor GP by using the secure communication channel as previously described.

In the above description, in particular of FIG. 10, all the described operations executed by the server SRV may alternatively be executed by a secure processor included in the terminal MT, such as the secure processor SE previously described.

It will be apparent to those skilled in the art that the implementations described herein are susceptible to various alternatives and applications. In particular, the implementations described herein are not limited to an embodiment in the form of garbled circuits for the components RNG1, ENC and FCC. Other methods such as program obfuscation methods may be used to make the code of a program impenetrable and thus obscure the operation of the program loaded in the processor, and/or prevent the operation of the program from being unveiled, or the modification of the program by an unauthorized person.

It should also be noted that some graphics processors equipping mobile terminals, in particular, may not be powerful enough to perform the operations described above. In some implementations, a main processor of a terminal may be used to perform all or some of the previously described functions in place of a graphics processor, the security of the transaction process being ensured by the implementation of these functions in the form of impenetrable programs. Such a program happens to be impossible, mathematically, to decode by reverse engineering. It is also not possible to exploit the input data of the program, if the result of its execution depends on a random value generated by the program. It should also be noted that a protected component can be the subject of side-channel analysis consisting in measuring variations in the component's electrical consumption or in the electromagnetic field emitted by the component. The architecture of such a component can also be analyzed by electron microscopy. In contrast, such analysis methods are ineffective in determining the semantics of an impenetrable program.

Moreover, displaying an image having portions of individually refreshed pixel patterns at random times and combining to form an intelligible image by exploiting the persistence of the human vision system is an example implementation, which can be implemented separately from a method of sharing a secret data. Thus, the implementations described herein are not limited to an authentication method combining a secret data sharing method, and the display of an image of a keypad having a randomly defined key distribution, in the form of a succession of frames that are humanly unintelligible individually. Indeed, in some implementations, it may be envisaged to authenticate a user without sharing secret data, solely on the basis of a secret code introduced by the user according to an image of a keypad having a randomly defined key distribution, displayed as a succession of frames that are individually humanly unintelligible. Moreover, the method of sharing secret data has uses other than the authentication of a user. For example, the method of sharing secret data can be implemented to establish a secure link between a terminal and a server or a secure processor included in the terminal.

It should also be noted that the displayed image of a keypad can be replaced by any other image in which the user is invited to select areas, each associated with a label or an icon, these zones having respective positions in the image, defined randomly. Thus, the labels or icons displayed may represent numbers, letters, symbols, pictograms, or messages that may for example present transaction data. The displayed image can show a challenge and zones to be selected presenting possible answers to the challenge, or labels of keys to be selected in a certain order specified by the challenge.

1. A method of authenticating a user, the method comprising:
executing, by a user terminal, an impenetrable program that configures the terminal to display, on a display screen of the terminal, an image including a plurality of selectable areas, each selectable area including a respective label, the plurality of selectable areas being distributed in the image in accordance with first random data, the image including frames that are individually unintelligible to the user, the frames being successively displayed on the display screen at a rate corresponding with persistence of a vision system of the user, such that the respective labels are intelligible to the user;
collecting, by the terminal, positions on the display screen, in relation to the image, designated by the user using an interface of the terminal;
transmitting, by the terminal to a secure processor, the positions on the display screen designated by the user;
verifying, by the secure processor, whether the positions on the display screen designated by the user, relative to the image, correspond to an authentication data of the user known to the secure processor, the user being authenticated if the positions designated by the user correspond to the authentication data.

2. The method of claim 1, further comprising transmitting, the secure processor, at least a portion of the impenetrable program to the terminal.

3. The method of claim 1, wherein the impenetrable program further configures the terminal to display transaction data.

4. The method of claim 1, wherein the impenetrable program configures the terminal to display the respective labels of the plurality of selectable areas in the image at respective positions in each selectable area, the respective labels being displayed using at least one of a size or a font that is specific to the impenetrable program.

5. The method of claim 1, wherein the displaying of the image by the terminal includes:
successively selecting a decomposition in complementary pixel patterns for each pixel or group of pixels of the image representing the respective labels; and
for each selected decomposition, generating complementary pixel patterns, so that the respective labels are visible on the display screen only if the complementary pixel patterns are displayed successively at a rate corresponding with the persistence of the vision system of the user.

6. The method of claim 5, wherein the display of the image by the terminal includes successively displaying, by the terminal, the generated complementary pixel patterns at randomly selected times spaced apart by a variable duration, such that the vision system of the user can combine them although they are displayed successively.

7. The method of claim 1, wherein the impenetrable program further configures the terminal to:
generate the first random data; and
transmit the first random data to the secure processor in an encrypted form, the method further comprising:
decrypting, by the secure processor, the encrypted form of the first random data;
determining, by the secure processor, the distribution of the respective labels in the image; and
determining, by the secure processor, a secret code entered by the user, the secret code being determined from the positions designated by the user and the distribution of the respective labels.

8. The method of claim 1, wherein the impenetrable program includes one of a random number generation component or a pseudo-random number generation component for generating second random data, the second random data being used to select a complementary pixel pattern decomposition for each pixel or group of pixels in the image a corresponding with each label of the respective labels.

9. The method of claim 7, further comprising establishing a link between the terminal and the secure processor, the link being secured using the first random data.

10. The method of claim 1, wherein the impenetrable program configures the terminal to utilize at least 80% of the computing resources of a processor running the impenetrable program.

11. The method of claim 1, wherein the impenetrable program includes a garbled circuit having logic gates distributed in plurality of ordered levels, the plurality of ordered levels including a first level including logic gates exclusively receiving input signals to the garbled circuit, the plurality of ordered levels including a second level having logic gates of exclusively receiving signals from logic gates belonging to previous levels or input values of the garbled circuit, each logic gate of the garbled circuit being associated with garbled values representing each possible bit value of each input bit and each output bit of the logic gate, each logic gate of the garbled circuit being associated with a truth table including, for each possible combination of input binary values of the logic gate, a value obtained by encryption of a garbled value representing an output value of the logic gate corresponding to the combination of the input binary values of the logic gate,
the execution of the impenetrable program comprising:
successively executing the levels of logic gates in an order of the ordered levels, the execution of a given level including executing all the logic gates of the given level, the execution of a logic gate of the given level including selecting a row of a truth table associated with the logic gate the given level as a function of the garbled input values of the logic gate of the given level, and decrypting the selected row to obtain a garbled output value of the logic gate of the given level, and
transferring resulting garbled output values to apply them to inputs of logic gates of a next level, from an output memory area to an input memory area so that the resulting garbled output values are taken into account when executing the logic gates of the next level.

12. The method of claim 11, wherein the execution of the garbled circuit is performed by an interpreter implemented, at least in part, by another garbled circuit.

13. The method of claim 8, wherein the first random data or the second random data is generated by, at least one of:
using a garbled circuit including a first level of logic gates associated with truth tables having differently ordered identical rows, so as to provide different output data for a same input data, output data of the first level of logic gates being provided to a next level of logic gates according to an order in which the output data of the first level of logic gates are provided by the first level of logic gates, or
by simultaneously launching execution of several identical operations in parallel, wherein the first or second random data generated depends on an order in which the execution the several identical operations end.

14. The method of claim 1, wherein the secure processor is:
included in a server to which the terminal is connected; or
is included in a device inserted in the terminal.

15. A terminal comprising a non-transitory machine-readable medium having instructions stored thereon, and at least one processor, the instructions, when executed by the at least one processor result in the terminal:
executing an impenetrable program configuring the terminal to display, on a display screen of the terminal, an image including a plurality of selectable areas, each selectable area including a respective label, the plurality of selectable areas being distributed in the image in accordance with a first random data, the image including frames that are individually unintelligible to a user, the frames being successively displayed on the display screen at a rate corresponding with persistence of a vision system of the user, such that the respective labels are intelligible to the user;
collecting positions on the display screen, in relation to the image, designated by the user of using an interface of the terminal; and
transmitting, to a secure processor, the positions on the display screen designated by the user, the user being authenticated by the secure processor if the positions designated by the user correspond to authentication data of the user, known to the secure processor.

16. (canceled)

17. A server to comprising a non-transitory machine-readable medium having instructions stored thereon, and at least one processor, the instructions, when executed by the at least one processor cause the server to:
receive, from a terminal, an authentication request from a user of the terminal;
generate an impenetrable program executable by the terminal, the impenetrable program, when executed by the terminal, configuring the terminal to display, on a display screen of the terminal, an image including a plurality of selectable areas, each selectable area including a respective label, the plurality of selectable areas being distributed in the image in accordance with first random data, the image including frames that are individually unintelligible to the user, the frames being successively displayed on the display screen at a rate corresponding with persistence of a vision system of the user, such that the respective labels are intelligible to the user;
transmit, to the terminal, the impenetrable program;
receive, from the terminal, positions on the display screen designated by the user in relation to the image; and
authenticate the user if the positions designated by the user correspond to authentication data of the user.

18. (canceled)

19. The terminal of claim 15, wherein executing the impenetrable program further configures the terminal to display the respective labels of the plurality of selectable areas in the image at respective positions in each selectable area, the respective labels being displayed using at least one of a size or a font that is specific to the impenetrable program.

20. The terminal of claim 15, wherein the displaying of the image by the terminal includes:
successively selecting a decomposition in complementary pixel patterns for each pixel or group of pixels of the image representing the respective labels; and
for each selected decomposition, generating complementary pixel patterns, so that the respective labels are visible on the display screen only if the complementary pixel patterns are displayed successively at a rate corresponding with the persistence of the vision system of the user.

21. The terminal of claim 20, wherein the display of the image by the terminal includes successively displaying, by the terminal, the generated complementary pixel patterns at randomly selected times spaced apart by a variable duration, such that the vision system of the user can combine them although they are displayed successively.

22. The terminal of claim 15, wherein the impenetrable program includes one of a random number generation component or a pseudo-random number generation component for generating second random data, the second random data being used to select a complementary pixel pattern decomposition for each pixel or group of pixels in the image corresponding with each label of the respective labels.

23. The terminal of claim 22, wherein the first random data or the second random data is generated by, at least one of:
using a garbled circuit including a first level of logic gates associated with truth tables having differently ordered identical rows, so as to provide different output data for a same input data, output data of the first level of logic gates being provided to a next level of logic gates according to an order in which the output data of the first level of logic gates are provided by the first level of logic gates, or
by simultaneously launching execution of several identical operations in parallel, wherein the first random data or the second random data generated depends on an order in which the execution of the several identical operations end.

24. The terminal of claim 15, wherein the impenetrable program configures the terminal to utilize at least 80% of computing resources of a processor running the impenetrable program.

25. The terminal of claim 15, wherein the impenetrable program includes a garbled circuit having logic gates distributed in a plurality of ordered levels, the plurality of ordered levels including a first level including logic gates exclusively receiving input signals to the garbled circuit, the plurality of ordered levels including a second level having logic gates exclusively receiving signals from logic gates belonging to previous levels or input values of the garbled circuit, each logic gate of the garbled circuit being associated with garbled values representing each possible bit value of each input bit and each output bit of the logic gate, each logic gate of the garbled circuit being associated with a truth table including, for each possible combination of input binary values of the logic gate, a value obtained by encryption of a garbled value representing an output value of the logic gate corresponding to the combination of the input binary values of the logic gate,
the execution of the impenetrable program by the terminal comprising:
successively executing the levels of logic gates in an order of the ordered levels, the execution of a given level including executing all the logic gates of the given level, the execution of a logic gate of the given level including selecting a row of a truth table associated with the logic gate the given level as a function of the garbled input values of the logic gate of the given level, and decrypting the selected row to obtain a garbled output value of the logic gate of the given level; and
transferring resulting garbled output values to apply them to inputs of logic gates of a next level, from an output memory area to an input memory area so that the resulting garbled output values are taken into account when executing the logic gates of the next level.

26. The terminal of claim 25, wherein the execution of the garbled circuit is performed by an interpreter implemented, at least in part, by another garbled circuit.

27. A non-transitory computer-readable medium having instructions stored thereon, the instructions, when executed by one or more processors, cause the one or more processors to:
execute an impenetrable program configuring a terminal to display, on a display screen of the terminal, an image including a plurality of selectable areas, each selectable area including a respective label, the plurality of selectable areas being distributed in the image in accordance with a first random data, the image including frames that are individually unintelligible to a user, the frames being successively displayed on the display screen at a rate corresponding with persistence of a vision system of the user, such that the respective labels are intelligible to the user;
collect positions on the display screen, in relation to the image, designated by the user using an interface of the terminal; and
transmit to a secure processor the positions on the display screen designated by the user, the user being authenticated by the secure processor if the positions designated by the user correspond to authentication data of the user, known to the secure processor.
